(19) United States
(12) Patent Application Publication
(10) Pub. No.: US 2014/0144959 A1
(43) Pub. Date: May 29, 2014

(54) ADJUSTABLE BOAT CARRIER

(71) Applicant: Yakima Innovation Development Corporation, Georgetown Grand Cayman (KY)

(72) Inventors: Chris Sautter, Portland, OR (US); Jason A. Sagen, Portland, OR (US); Ross M. Miyao, Sherwood, OR (US)

(73) Assignee: Yakima Innovation Development Corporation, Georgetown Grand Cayman (KY)

(21) Appl. No.: 13/874,364

(22) Filed: Apr. 30, 2013

Related U.S. Application Data
(60) Provisional application No. 61/640,595, filed on Apr. 30, 2012.
(60) Provisional application No. 61/677,995, filed on Jul. 31, 2012.

(51) Int. Cl. B60R 9/045

(52) U.S. Cl. CPC B60R 9/045
USPC 224/321

(57) ABSTRACT

An adjustable saddle-type boat mount is described. A boat mount may include a central base and two wing assemblies pivotably attached to opposing lateral sides of the base. The wing assemblies may be selectively pivoted between a collapsed position and at least one in-use position.

### CROSS-REFERENCE TO RELATED APPLICATIONS

This application claims priority under 35 U.S.C. §119(e) to U.S. Provisional Patent Applications: Ser. No. 61/640,595 filed Apr. 30, 2012 and Ser. No. 61/677,995 filed Jul. 31, 2012, all of which are incorporated herein by reference in their entireties for all purposes.

This application also incorporates by reference in their entireties the following U.S. Patents: U.S. Pat. No. 6,164,507 issued Dec. 26, 2000, U.S. Pat. No. 7,036,698 issued May 2, 2006, U.S. Pat. No. 7,131,561 issued Nov. 7, 2006, U.S. Pat. No. 8,136,708 issued Mar. 20, 2012 and U.S. Pat. No. 8,245,893 issued Aug. 21, 2012.

### FIELD OF THE INVENTION

The present disclosure relates to vehicle-mounted racks, and more particularly to load-carrying devices for use with a crossbar mounted to a vehicle roof.

### INTRODUCTION

Vehicles are often fitted with racks for carrying cargo boxes, recreational equipment mounts, and various other types of load carriers. These vehicle racks may include crossbars, rails, or other elongate structural members extending over the roof of the vehicle or adjacent the rear of the vehicle. For example, typical roof rack systems may include a pair of crossbars mounted o top of a vehicle, the crossbars being oriented perpendicular to the direction of vehicle travel.

Vehicle roof racks are often used for carrying boats such as canoes or kayaks. One type of vehicle roof rack for carrying boats is generically referred to as a saddle mount. Saddle mounts are typically configured to hold a boat, such as a kayak or canoe, in an upright position, cradling the keel and/or hull on opposing sides.

### SUMMARY

In a first example, a system for carrying a boat on a vehicle having an elongate axis parallel to a direction of vehicular travel may include a crossbar and a pair of towers configured to mount the crossbar on top of a vehicle, the crossbar being substantially perpendicular to the elongate axis. A load-carrying device may be mounted on the crossbar. The load-carrying device may include a central platform having a major surface facing generally upward, a first support arm pivotably connected to a first lateral edge of the central platform, and a second support arm pivotably connected to a second lateral edge of the central platform opposite the first lateral edge. Each support arm respectively may include a resilient shell operatively attached to an upper surface of the arm, each resilient shell including a load-bearing face. Each support arm may be independently pivotable with respect to the central platform.

In a second example, a load-carrying device for use on a vehicle rack may include a base having a major surface and a mounting surface opposite the major surface and including a clamp configured to secure the base to a crossbar of a vehicle rack. A first wing assembly may be pivotably connected to a first lateral edge of the base. A second wing assembly may be pivotably connected to a second lateral edge of the base opposite the first lateral edge, each wing assembly respectively including an elongate support arm pivotably attached to the base, a load-bearing portion having a load-bearing surface and operatively attached to the support arm, and a locking mechanism operatively attached to the support arm. Each wing assembly may be configured to pivot independently on an axis substantially perpendicular to a long axis of the crossbar. Each locking mechanism may be configured to selectively fix the respective support arm in at least a first position in which the wing assembly is substantially parallel to the major surface of the base and a second position in which the wing assembly is pivoted at an oblique angle relative to the major surface of the base.

### DRAWINGS

FIG. 1 is an isometric view of an illustrative vehicle roof rack for carrying boats, shown installed on a vehicle roof, with the roof rack including a pair of load-carrying devices in the form of adjustable saddle-type boat mounts.

FIG. 2 is a schematic diagram of an illustrative boat mount shown in an elevation view.

FIG. 3 is an isometric view of an illustrative boat mount in an in-use position.

FIG. 4 is a rear elevation view of the boat mount of FIG. 3 showing collapsed and in-use positions.

FIG. 5 is a bottom plan view of the boat mount of FIG. 3.

FIG. 6 is a side elevation view of the boat mount of FIG. 3 attached to an illustrative slotted crossbar (shown in cross section).

FIG. 7 is a partial isometric view of a portion of the boat mount of FIG. 3 with top covers removed.

FIG. 8 is a partial isometric view of another portion of the boat mount of FIG. 3 with wing portions and other components removed to show a support arm and hub mechanism.

FIG. 9 is an isometric view of a pivotable portion of the boat mount of FIG. 3.

FIG. 10 is a plan view of the pivotable portion of FIG. 9.

FIG. 11 is a front elevation view of another portion of the boat mount of FIG. 3, showing illustrative clamping assemblies.

FIG. 12 is a rear isometric view of another portion of the boat mount of FIG. 3, showing an illustrative locking mechanism for the clamping assemblies of FIG. 11.

### DESCRIPTION

The present disclosure describes a system and apparatus for securing a load to a vehicle-mounted rack. Vehicle racks may be mounted on any type of vehicle (e.g., car, van, truck, etc.), and many vehicle manufacturers include factory-installed racks on some vehicle models. While racks are often mounted on the roofs of vehicles, racks may also be mounted on other parts of a vehicle, such as the trunk or rear of the vehicle. Vehicle racks include bars, such as crossbars and rails, for securing and supporting loads.

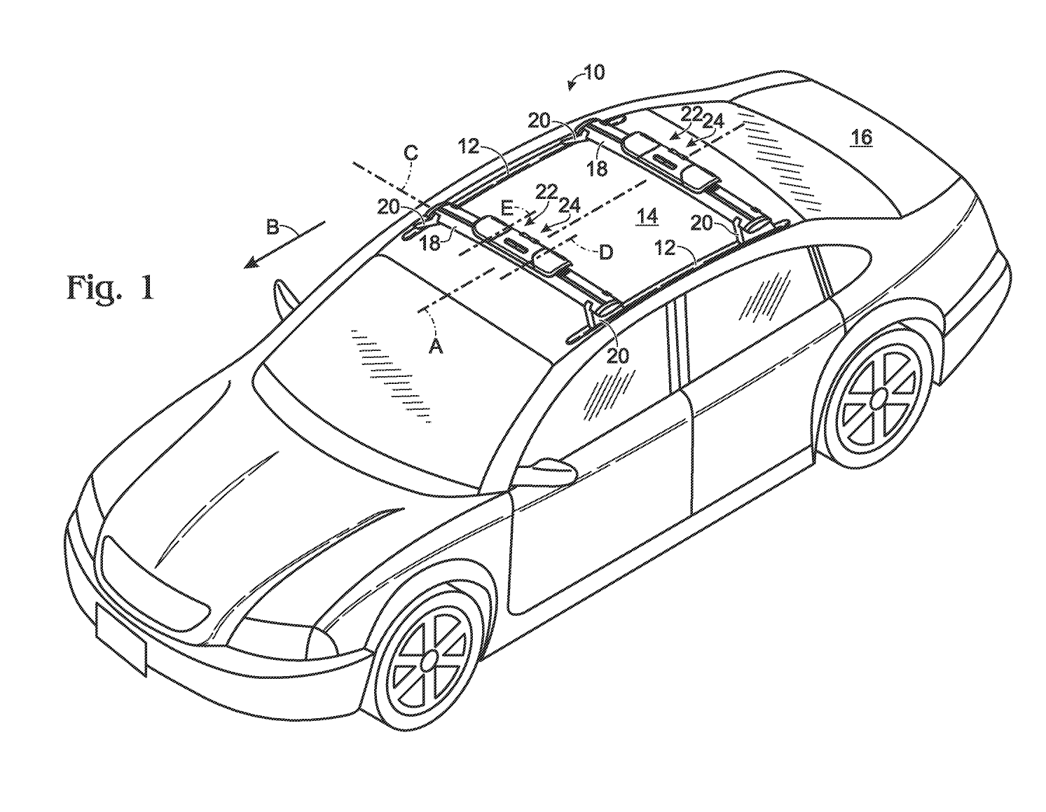

An example of a vehicle roof rack is shown generally at 10 in FIG. 1. Unless otherwise specified, vehicle roof rack 10 and/or its various components may, but are not required to, contain at least one of the structure, components, functionality, and/or variations described, illustrated, and/or incorporated herein. As shown in FIG. 1, vehicle roof rack 10 may include a pair of rails 12 attached to a roof 14 of a vehicle 16. Vehicle 16 has an elongate axis A and generally travels in a direction of travel B. At least one crossbar 18 extends between rails 12. Crossbar 18 has a long axis C, and is substantially perpendicular to vehicle axis A. In the example shown in FIG. 1, rack 10 includes first and second crossbars 18. Crossbars 18 may be supported or mounted relative to roof 14 and/or rails 12 by any suitable structure, such as a pair of feet, towers 20 or other appropriate clamp devices. A load-carrying accessory 22, also referred to as a load-carrying device, which is configured to at least partially support a load, is mounted to, secured to, and/or supported by at least one of the crossbars 18. In the example shown in FIG. 1, the rack includes first and second load-carrying devices 22 mounted or secured respectively to first and second crossbars 18.

As shown in FIG. 1, each load-carrying device 22 may be in the form of an adjustable saddle-type boat mount 24, which is suitable for securing or carrying a boat such as a kayak or canoe (not shown) in an upright orientation. Although load-carrying device 22 in the examples presented herein is shown in the form of adjustable saddle-type boat mounts, it should be understood that load-carrying device 22 and/or its various components may be configured and/or used for the carriage of a wide range of articles. References to a “boat” should be understood to encompass any load or article that might be carried on, and/or supported by, the load-carrying accessory described.

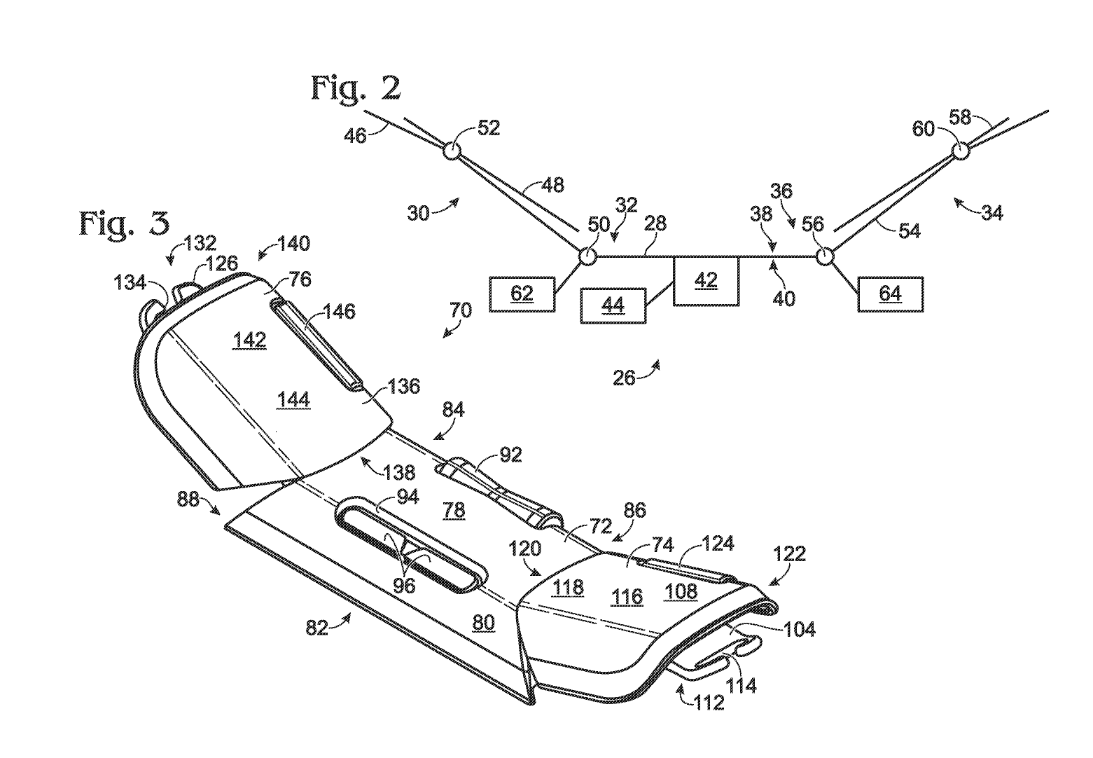

FIG. 2 is a schematic diagram of an illustrative boat mount 26 according to the present disclosure, shown in elevation. Boat mount 26 includes a central base 28, a first wing assembly 30 pivotably attached to a first side portion 32 of base 28, and a second wing assembly 34 pivotably attached to a second side portion 36 of base 28. Base 28 may include any suitable structure configured to support a load on an upper surface and to be attachable to a support such as a crossbar. Accordingly, base 28 may be a generally planar structure including a first major surface 38 configured as a load-bearing surface and a second major surface 40 opposite the first major surface and configured to interface with a crossbar.

To facilitate load bearing, including adding and removing a boat from the boat mount, surface 38 may include structures such as rollers and/or guides. To facilitate attachment to a crossbar, base 28 may include a clamping assembly 42 connected to the base and configured to interface with an expected crossbar. An actuator 44 may be operatively connected to the clamping assembly and configured to allow a user to selectively clamp and unclamp the boat mount from the crossbar.

Each wing assembly may include multiple structures configured to generally conform to and cradle the hull of a boat. First wing assembly 30 may include a first support arm 46 and a first load-bearing portion 48. Support arm 46 may provide the pivotable connection between wing assembly and base, and may be connected to base 28 at a first hinge assembly 50. As shown in FIG. 2, load-bearing portion 48 may be attached to support arm 46 at a pivotable connection 52. Connection 52 may be spaced from opposite ends of load-bearing portion 48, and support arm 46 may be curved or angled in such a way to allow the load-bearing portion to pivot a small amount as needed, for example, to conform to a boat hull. Correspondingly, second wing assembly 34 may include substantially identical components and mechanisms, including a second support arm 54 connected to base 28 by a second hinge assembly 56, and a second load-bearing portion 56 connected to support arm 54 by a pivotable connection 60.

The wing assemblies of boat mount 26 may be configured to be independently pivotable, and may each include a ratcheting and/or locking mechanism configured to selectively lock the respective arm in one of a plurality of positions relative to the base. For example, a first locking mechanism 62 may be operatively connected to first hinge assembly 50 and a second locking mechanism 64 may be operatively connected to second hinge assembly 56. Accordingly, boat mount 26 may be configured such that wing assemblies 30 and 34 are placeable in at least a collapsed position, with the wing assemblies flat and substantially coplanar with the central base, and one or more in-use positions, with the wing assemblies locked in positions that are pivoted upward relative to the base, creating a cradle for a boat hull.

Turning to FIGS. 3-12, an example of boat mount 26 and various components thereof will now be described in detail. FIG. 3 shows an isometric view of an adjustable saddle-type boat mount generally indicated at 70, shown from a front overhead angle. “Front” is used here to indicate the leading edge of the device when mounted on a vehicle, and “rear” indicates the trailing edge. Additionally, the terms “up,” “upward,” or “top,” and “down,” “downward,” or “bottom” will be used to indicate those general directions as if the device were mounted on a vehicle. FIG. 4 shows a rear elevation view of boat mount 70, and indicates various positions of the device.

Boat mount 70 includes a central base 72, also referred to herein as a central “platform,” and two wing assemblies 74 and 76. Central base 72 includes a generally planar major surface 78. Surface 78 faces generally upward and is configured to function as a load-bearing surface. Accordingly, central base 72 includes an outer casing 80 and underlying compliant padding and rigid framework (described further below) configured to provide a tough and resilient surface. Outer casing 80 may include any suitable material that is flexible, durable, and relatively smooth, and may include an elastomer. Outer casing 80 may also be shaped and configured to function as a fairing for the device, providing a streamlined and relatively quiet profile when mounted on a moving vehicle. Central base 72 includes peripheral edge portions such as a leading edge portion 82, a trailing edge portion 84 opposite the leading edge portion, and first and second opposing lateral edge portions 86 and 88. A bottom surface is generally indicated at 90, and is disposed opposite major surface 78.

Central platform or base 72 may also include suitable structures configured to guide or facilitate loading of a boat onto the device. In the example shown, central base 72 includes a concave shaped roller 92 centrally located on trailing edge portion 84. Roller 92 is configured to spin freely on an axis substantially parallel to long axis C of the crossbar, and is generally cylindrical with a reduced diameter in the middle of the roller to guide a keel of the boat toward the center of the platform. An outer surface of roller 92 is textured or ridged to provide traction. In some examples, a plurality of rollers may be included on trailing edge portion 84.

Central base 72, including major surface 78 may include access points for various actuators or interfaces of the boat mount. In the example shown, an aperture 94 is included in major surface 78 near leading edge portion 82. Aperture 94 is configured to allow user access to one or more actuators 96 for a clamping assembly of the device. The actuators and aperture are configured such that the actuators are flush with or below major surface 78 so as not to interfere with load bearing and/or damage the actuators. Additionally, pushbuttons 98 and 100 as well as a central clamp locking interface 102 protrude from trailing edge portion 84. These components are described in further detail below.

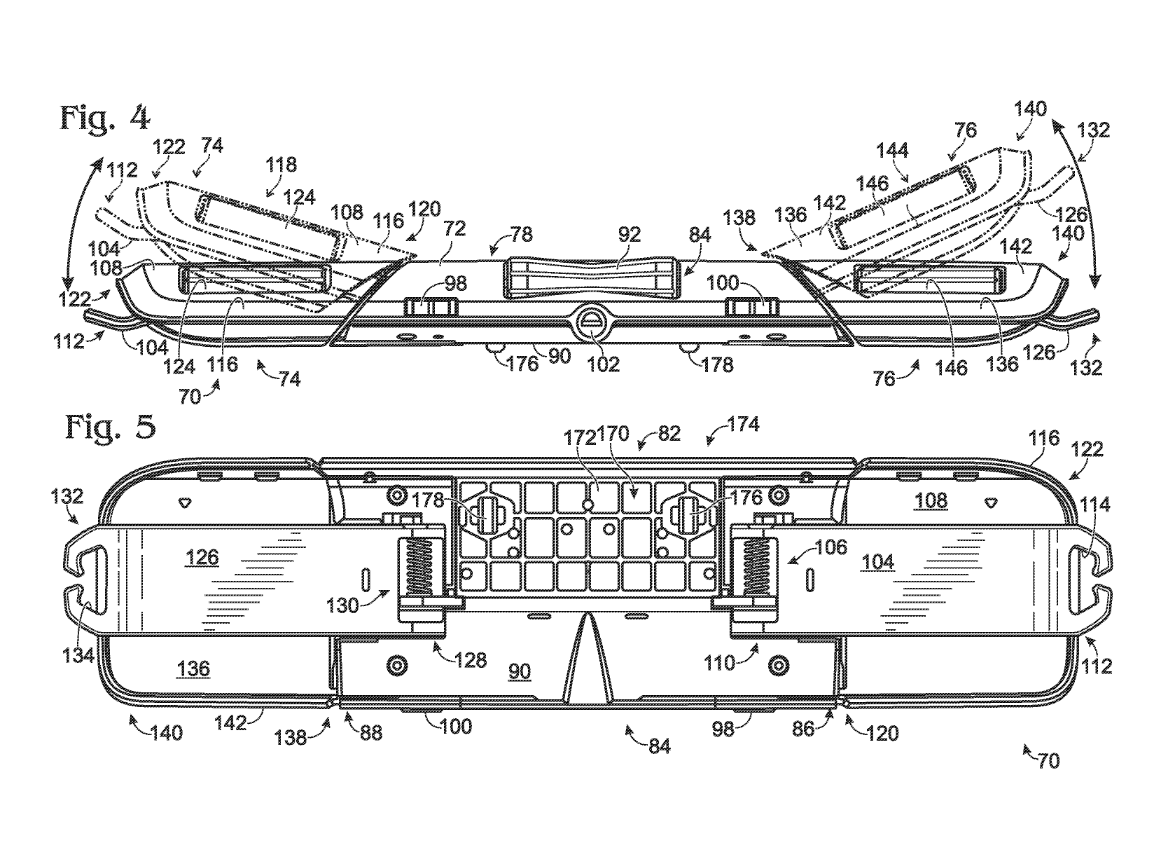

With continuing reference to FIGS. 3 and 4, and further reference to the bottom plan view of FIG. 5, wing assembly 74 may be any suitable load-bearing assembly that is operatively connected to central base 72 by a selectively pivotable connection. In the example shown, wing assembly 74 includes a support arm 104 pivotably connected to lateral edge 86 of base 72 at hinge assembly 106, and a resilient shell portion 108 attached to a top surface of support arm 104, and substantially covering a length of the support arm.

Support arm 104 may include any suitable elongate structure configured to provide a pivotable connection at one end and provide rigid, cantilevered support for a load-bearing surface. In the example shown, support arm 104 is an elongate, generally rectangular member connected to base 72 at a proximal end portion 110 and terminating in a distal end portion 112. The support arm may include raised, curved, or angled portions or surfaces. Arm 104 includes an aperture 114 in distal end portion 112. Aperture 114 may be any suitable hole or aperture through arm 104, and may be configured to accept a strap or tie-down device. As shown in the example of FIGS. 3 and 5, peripheral enclosure of aperture 114 may be incomplete, forming a C-shaped hole having a gap for passing a strap or other device into the aperture without lengthwise threading.

Resilient shell portion 108 may include any load-bearing member configured to cradle a boat hull. In the example shown, resilient shell portion 108 includes an outer casing 116 over an underlying rigid frame and compliant padding (described further below). Resilient shell portion 108 is a generally rigid, generally polygon-shaped structure, having a resilient load-bearing face 118. Load-bearing face 118 functions as a contact surface for one side of a boat hull. Boat hulls may be of various shapes and sizes. Accordingly, resilient shell portion 108 may be pivotably mounted to support arm 104 with the pivotable mount being spaced from both a first end 120 and a second end 122 of the shell portion.

A length of resilient shell portion 108, as defined between the first and second ends, is shorter than the overall length of support arm 104, to which the shell portion is mounted. Accordingly, shell portion 108 could not pivot, despite the pivotable connection, if the surfaces of the shell portion and the support arm were parallel. For at least this reason, the upper surface of support arm 104 is bent, angled, and/or raised such that the pivotable connection point is spaced from the rest of the support arm, allowing limited pivoting of shell portion 108. Additionally, the pivotable connection between the shell portion and the support arm may be biased against pivoting, to keep the shell portion from rattling or moving relative to the support arm except when under load. An example of this arrangement is best shown in FIG. 8, described below.

As with base 72, wing assembly 74 may include suitable structures configured to guide or facilitate loading of a boat onto the device. In the example shown, wing assembly 74 includes a trailing-edge roller 124 generally similar to roller 92. Roller 124 is substantially cylindrical, but unlike roller 92 does not include any guiding features. Roller 124 is expected to be contacted by a side of the boat hull and does not itself need to provide centering guidance.

Wing assembly 76 includes components and mechanisms substantially identical to those in wing assembly 74. Accordingly, wing assembly 76 includes a support arm 126 having a proximal end portion 128 connected to lateral edge portion 88 of base 72 by a hinge assembly 130 and a distal end portion 132 having an aperture 134. A resilient shell portion 136 having first and second ends 138 and 140 is pivotably attached to an upper surface of support arm 126, and includes an outer casing 142 forming a load-bearing face 144. A trailing-edge roller 146 is also included. Functioning and arrangement of these components are substantially as described above regarding wing assembly 74.

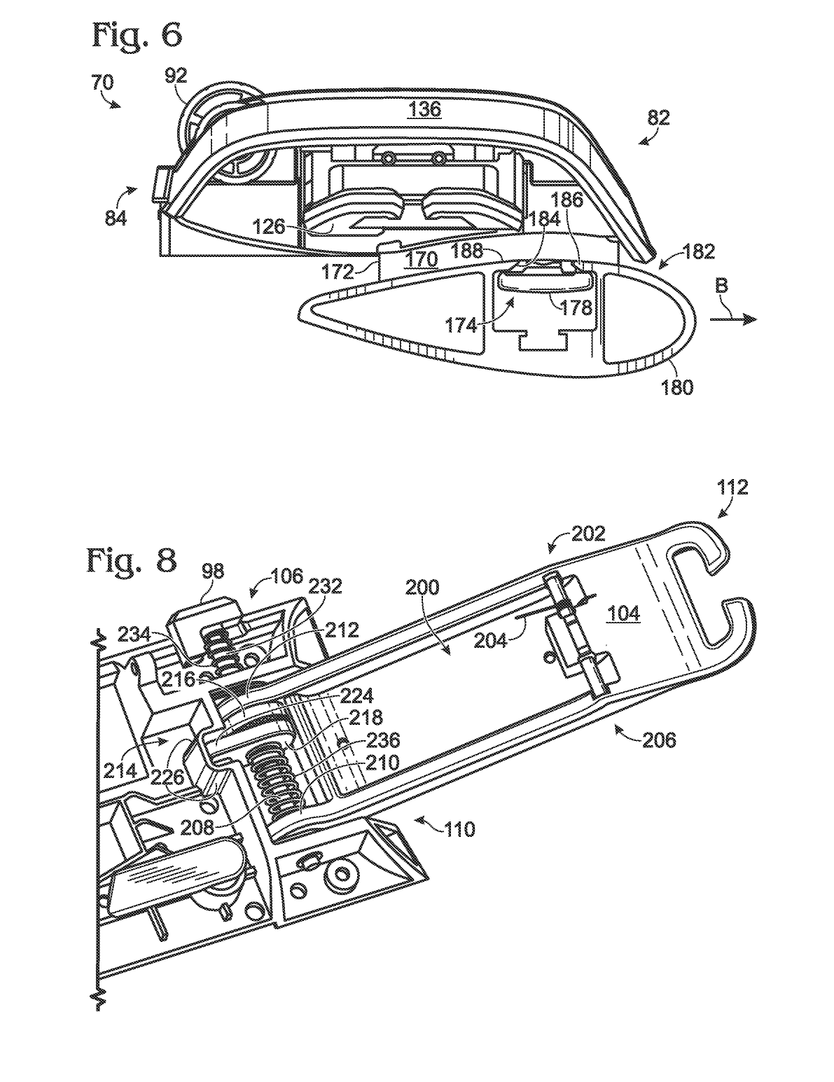

FIG. 4 shows the wing portions of boat mount 70 in various positions. In solid lines, the boat mount is shown in a horizontal or collapsed position 160 with support arms lowered and major surface 78 substantially aligned with load-bearing faces 118 and 144. In collapsed position 160, outer casings 80, 116, and 142 may together form an overall fairing for the boat mount, facilitating a compact device with a streamlined appearance as well as reducing drag and associated wind noise when a supporting vehicle is in motion. The side profile presented by boat mount 70 in collapsed position 160 is shown in FIG. 6.

Returning to FIG. 4, each wing assembly is shown in phantom pivoted into an in-use position 162. The wing assemblies of the example shown in the drawings are independently pivotable. Accordingly, wing assembly 74 is shown at a different angle than wing assembly 76. However, in practice, wing assemblies 74 and 76 may typically be placed at substantially identical (although mirrored) angles to accommodate a symmetrical boat hull. It is noted that boat mount 70 has an in-use position which is defined as having both of the wing assemblies pivoted up away from horizontal, and this in-use position may typically include having the wing assemblies at substantially identical mirrored angles. Additionally, each wing assembly may be said to have its own in-use position, defined as pivoted upward away from horizontal. As will be described below, the wing assemblies are pivotable into a plurality of angled positions, and multiple in-use positions are possible.

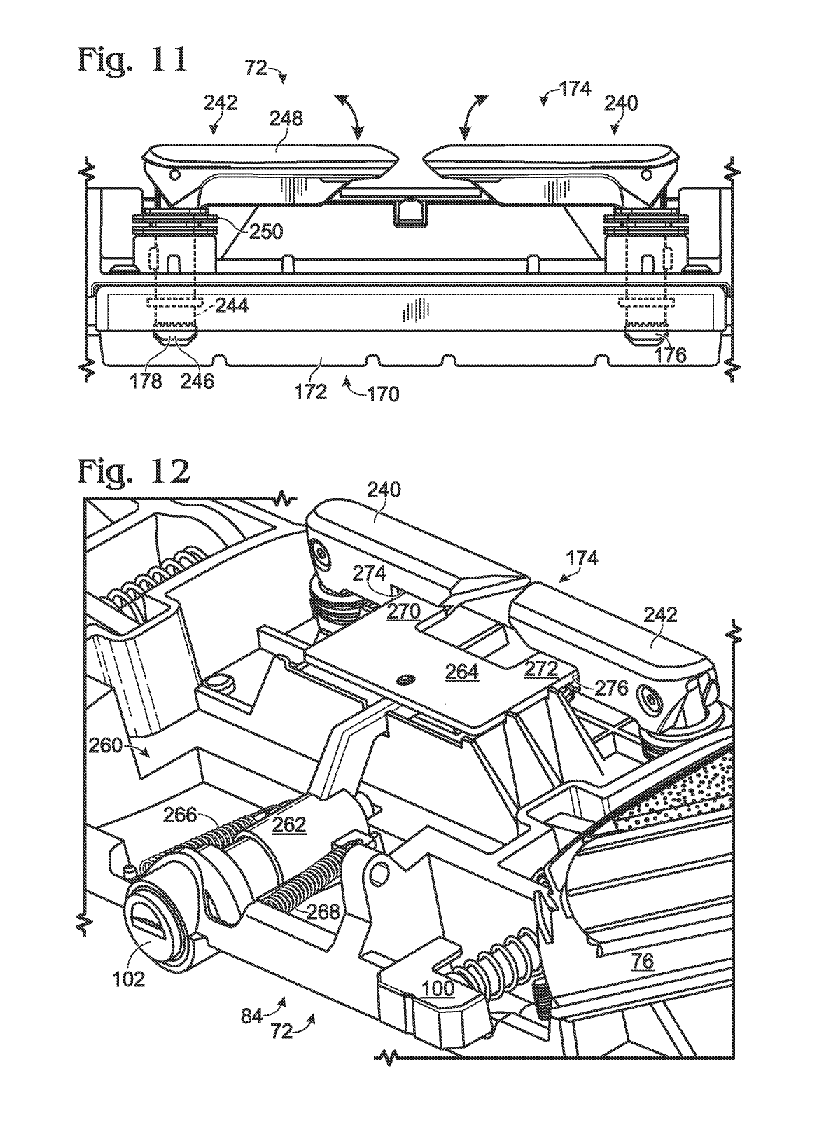

Referring now again to the bottom view of FIG. 5, central base 72 of boat mount 70 includes a mounting interface 170 on bottom surface 90. Mounting interface 170 may include any suitable structure configured to facilitate attachment of boat mount 70 to a crossbar. In the example shown, mounting interface 170 includes a mounting pad 172 and a clamping assembly 174. Mounting pad 172 is a resilient, concave structure configured to interface with an upper surface of a crossbar. Clamping assembly 174 may include any suitable clamping mechanism configured to attach the boat mount securely to a crossbar. In the example shown, clamping assembly 174 includes two cleats 176 and 178 configured to attach the device to a slotted crossbar. Clamping assembly 174 is described further below with respect to FIGS. 6 and 11.

FIG. 6 is an end elevation view of boat mount 70 attached to a slotted crossbar 180. Boat mount 70 is depicted in collapsed position 160, and FIG. 6 shows the compact, streamlined profile provided by the aligned upper surfaces of the base and wing assemblies. Notably, the leading edge of boat mount 70 extends downward to create a front fairing for the device and bringing the upper surface of the boat mount adjacent to an upper surface 182 of crossbar 180.

Mounting interface 170, including mounting pad 172, is in contact with upper surface 182, and boat mount 70 is secured to crossbar 180 via the cleats of the clamping assembly. Cleat 178 is visible in FIG. 6, and shows a transverse orientation of cleat 178 relative to a longitudinal slot 184 in crossbar 180. The clamping assembly is configured to pull the shaped head of cleat 178 up under lips 186 and 188 of the slot, pinching the lips between the cleat and the mounting surface of boat mount 70. While an integrated, cleated clamping assembly and a slotted crossbar are shown in the drawings, any of the various other clamps and crossbars known in the art may be used to secure boat mount 70 to a vehicle rack.

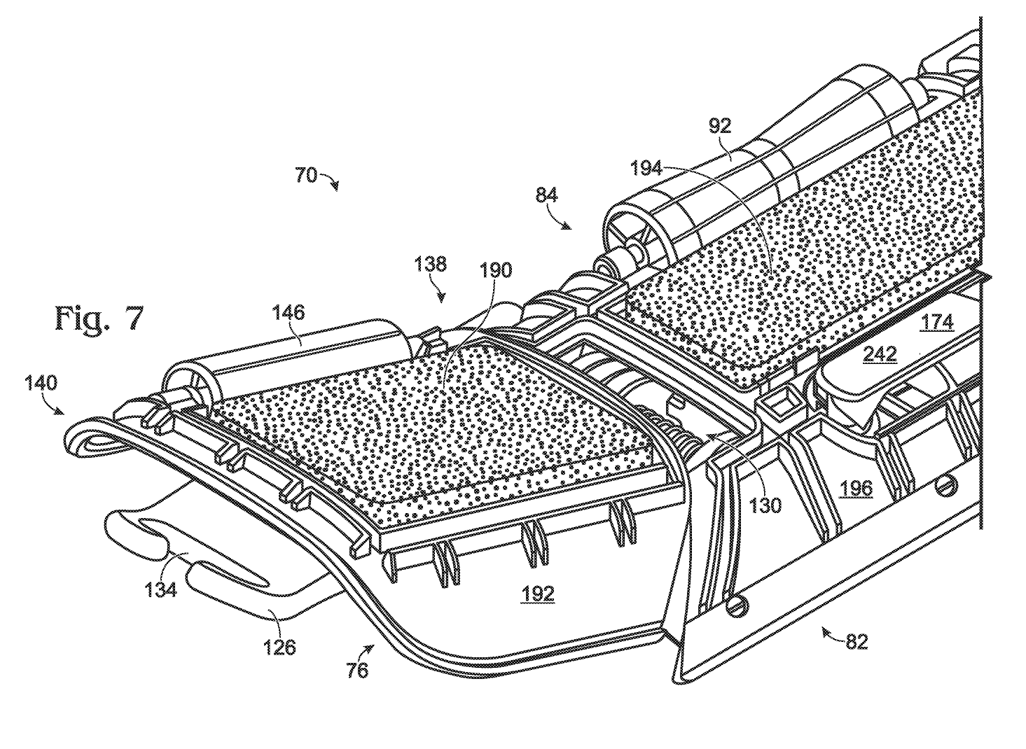

FIG. 7 is an isometric view of wing assembly 76 and a portion of central base 72, with the upper casing removed to show an illustrative arrangement of underlying padding and framework. Wing assembly 76 includes a compliant foam pad 190 atop a rigid wing frame 192, and central base 72 includes a compliant foam pad 194 atop a rigid base frame 196. Rigid frames 192 and 196 may include any suitable rigid members and materials. In the example shown, rigid frames 192 and 196 are aluminum structures. Similar structures are included in wing assembly 74.

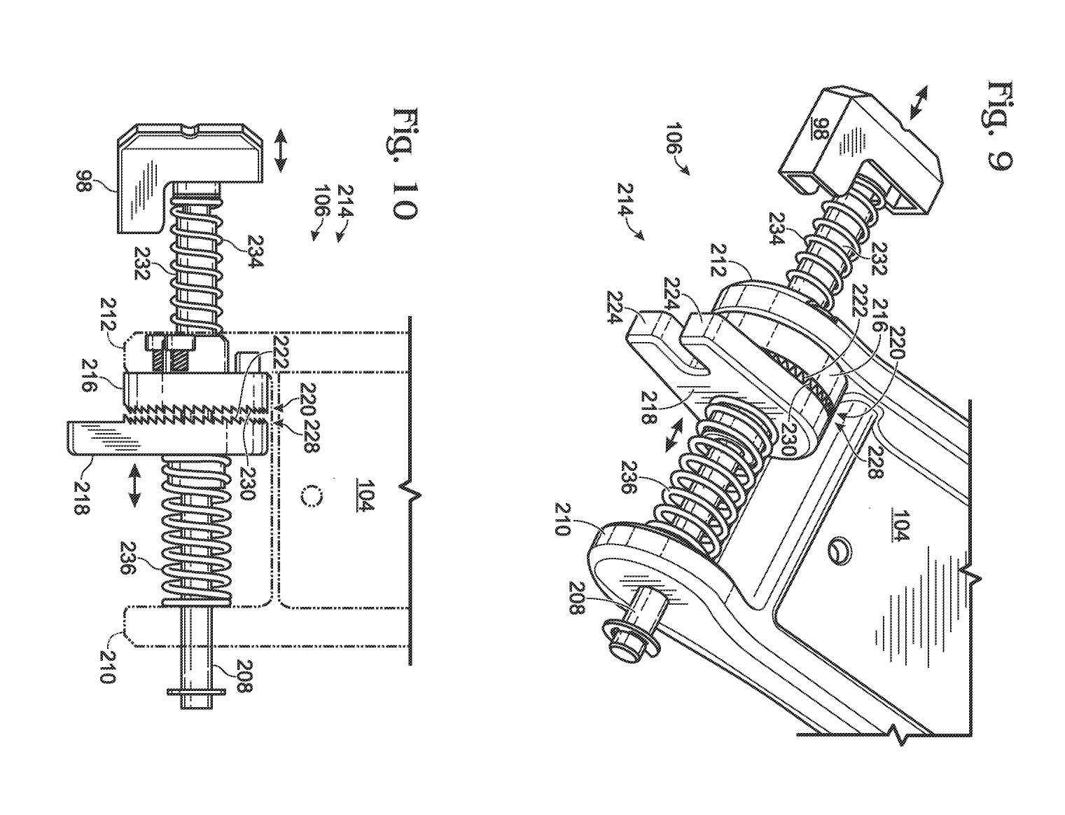

FIG. 8 is an isometric view of wing assembly 74 and a portion of central base 72, with upper components including resilient shell portion 108 removed to show an upper surface 200 of arm 104 and hinge assembly 106. Hinge assembly 106 is shown in further detail in FIGS. 9 and 10. For efficiency, arm 104 and hinge assembly 106 will be described in detail, with the understanding that arm 126 and hinge assembly 130 include corresponding parts and operation.

Arm 104 includes a pivoting hinge 202 disposed between proximal end 110 and distal end 112 for attaching resilient shell portion 108. As described above, pivoting hinge 202 includes a biasing spring 204 configured to resist pivoting of portion 108 on the arm. As also described above, pivoting hinge 202 is attached to a raised surface or edge 206 of arm 104 to accommodate limited pivoting of the shell portion.

Arm 104 is pivotally attached to base 72 by hinge assembly 106, as shown in FIGS. 8-10. Hinge assembly 106 may include any suitable apparatus configured to allow pivoting of arm 104 about an axis that is substantially parallel to elongate axis A of the supporting vehicle. In the example shown in the drawings, hinge assembly 106 includes a hinge pin 208 passing axially through apertures in hinge knuckles 210 and 212 at the proximal end of arm 104. A locking mechanism 214 is operatively connected to hinge assembly 106.

Locking mechanism 214 may include any suitable device configured to selectively fix arm 106 in a plurality of pivoted orientations relative to base 72. In the example shown, locking mechanism 214 includes a hub 216 rotationally coupled to knuckle 210 of arm 106, and a travelling member 218 operatively attached to pushbutton 98. Hub 216 is rotationally coupled to arm 106, and is bolted or otherwise affixed to knuckle 210. In other examples, hub 216 may be a unitary part of or may include an extension of either one of the knuckles.

Hub 216 includes a mating surface 220 having axially-protruding teeth 222 spaced around the periphery. Travelling member 218 is a block having a central aperture to allow hinge pin 208 to pass through, and in this example includes two extensions 224 that ride on opposing sides of a complementary ridge or rail in base 72. Travelling member 218 is generally free to move along the hinge axis, but is constrained to a discrete length of travel by walls 226 formed in base 72. Travelling member 218 is also rotationally fixed, because extensions 224 straddling the rail in base 72 prevent rotation of the member.

Travelling member 218 is coaxial with hub 216, and includes a mating surface 228 facing mating surface 220 of hub 216. Mating surface 228 includes a plurality of teeth 230 complementary to teeth 222. Teeth 222 and 230 may be any suitable size and shape configured to rotationally couple hub 216 and travelling member 218 when engaged. For example, teeth 222 and 230 may include complementary square or peaked teeth, or may include castelled surfaces. In the example shown, teeth 222 and 230 are ramped. The ramped teeth are configured to prevent rotational slipping in one direction (corresponding to a lowering of arm 106), but to slip or ratchet past each other in the other direction (corresponding to a raising of arm 106).

Travelling member 218 is configured to be selectively engaged and disengaged with hub 216. Specifically, pushbutton 98 is operatively attached to member 218 by a shaft 232 coaxial with hinge pin 208. An actuator in the form of pushbutton 98 is biased axially away from hub 216 by a button biasing spring 234. Travelling member 218 is biased axially toward hub 216 by a member biasing spring 236, and subsequently the facing mating surfaces and teeth of member 218 and hub 216 are biased toward engagement.

The locking mechanism is configured such that depressing pushbutton 98 overcomes the biasing force of springs 234 and 236 and urges travelling member 218 away from hub 216 thereby urging the mating surfaces out of engagement (see FIG. 10). This movement causes teeth 222 and 230 disengage from each other, and arm 106 is free to pivot on hinge pin 208 in either direction. Releasing pushbutton 98 allows spring 234 to bias pushbutton 98 away from hub 216 and allows spring 236 to urge the mating surfaces of hub 216 and travelling member 218 into engagement. Engagement of the teeth locks arm 106 into a fixed position relative to the base (see FIG. 9). As described above, arm 106 may be ratcheted upward by a user without depressing pushbutton 98 if teeth 222 and 230 are ramped as shown in the drawings. However, arm 106 will remain locked in position if a downward force is applied to the arm by a user or by a load such as a boat, unless pushbutton 98 is pressed.

Turning to FIG. 11, a portion of boat mount 70 is shown in elevation viewed from the leading edge of the device toward the trailing edge. Clamping assembly 174 may be any suitable assembly configured to attach or secure boat mount 70 to a crossbar. Crossbars may include various configurations and cross-sections, such as round bars, square bars, wing-shaped bars, and/or oval bars, any or all of which may include a longitudinal slot. Accordingly, various clamping solutions may be utilized, and any suitable clamping assembly may be included in the boat mount. In some examples, a separate docking device may be attached to the body of the boat mount and clamped to the crossbar. For example, suitable cleated clamping assemblies that may be used as a separate docking device or integrated into boat mount 24 are described in U.S. patent application Ser. Nos. 13/873,006 and 13/512,267, which are hereby incorporated by reference in its entirety for all purposes. In the example shown in the drawings, clamping assembly 174 is an integrated, cleated clamping assembly configured to attach the boat mount to a slotted crossbar.

As shown in FIG. 11 with additional reference to FIG. 6, clamping assembly 174 includes a pair of substantially identical clamps 240 and 242 spaced apart on boat mount 72. Describing only clamp 242 for convenience, each clamp includes a shaped cleat 178 having a stem portion 244 terminating in an enlarged head portion 246. Clamping assembly 174 is configured such that head portion 246 of cleat 244 is insertable into a slot in the crossbar. Clamping of the boat mount to the crossbar is accomplished by pinching a portion of the crossbar between head 246 and base 72. In the example shown, clamp 242 includes an actuator in the form of a cam handle 248, a cam interface in the form of flat washer or washers 250, and may include an axial biasing mechanism in the form of a spring washer assembly such as a stack of one or more Belleville washers or one or more wave spring washers (not shown).

Clamp 242 is disposed in base 72 with cam handle 248 accessible from load-bearing major surface 78 and with stem 244 passing through an aperture in the base such that head portion 246 depends from mounting pad 172 in a position that facilitates interfacing with the crossbar.

To operate the clamp, cam handle 248 may be pivoted upward to release the downward force on the flat washers from the cam handle and move stem 244 axially downward. Cleat 178 is thereby moved away from base 72. Cam handle 248 may then be rotated to rotate cleat 178 and to align shaped head portion 246 to allow it to pass unimpeded into the crossbar slot. In the example shown, cleat 178 is in the form of an inverted “T,” allowing the cleat to be rotated 90 degrees to put it either into or out of alignment with the slot opening. Once the cleat head is inserted into the slot, cam handle 248 is rotated 90 degrees or one quarter-turn to place the head portion transverse to the slot opening. Cam handle 248 may then be pivoted down to place cam force on flat washers 250 and draw head portion 246 of cleat 178 up under opposing lips of the slot, clamping the base to the slot in the crossbar.

FIG. 12 is an isometric view of a portion of base 72 with casing and padding removed, showing a clamp locking assembly 260. Clamp locking assembly 260 may include any suitable apparatus configured to selectively lock one or more of clamps 240 and 242 in a clamped position. In the example shown, clamp locking assembly 260 includes locking interface 102 of a biased barrel 262 operatively connected to a clamp locking plate 264. Biased barrel 262 is a generally cylindrical barrel that may be axially repositioned on an axis parallel to elongate axis A. Repositioning of the barrel includes repositioning between an unlocked position with the barrel protruding outward from trailing edge portion 84 and a locked position with the barrel pushed inward a discrete distance toward leading edge portion 82. Barrel 262 may be locked in the pushed-in position, requiring the user to use a key via locking interface 102 to enable subsequent repositioning of the barrel. Barrel 262 is biased toward the unlocked position by springs 266 and 268.

Barrel 262 is coupled to locking plate 264. Accordingly, locking plate 264 repositions toward and away from leading edge portion 82 along with the barrel. Locking plate 264 includes two extensions 270 and 272 that are configured to engage respective corresponding slots 274 and 276 in clamps 240 and 242. When locking plate 264 and barrel 262 are in the locked position, extensions 270 and 272 are inserted into slots 274 and 276, preventing repositioning of the cam handles and consequently preventing unclamping of the clamping assembly. When locking plate 264 and barrel 262 are in the unlocked position, extensions 270 and 272 are withdrawn from the slots and the cam handles are free to be repositioned by a user.

In some examples, a boat mount according to this disclosure may be used in conjunction with other systems and apparatuses such as those described, for example, in U.S. Pat. Nos. 7,036,698 and 8,245,893.

Based on the above description and the associated drawings, the following examples in the form of numbered paragraphs describe various embodiments of apparatuses and methods of the disclosure.

A. A rack system for carrying a boat on a vehicle having an elongate axis parallel to a direction of vehicular travel, the system comprising:

a crossbar and a pair of clamp devices configured to mount the crossbar on top of a vehicle in an orientation perpendicular to the elongate axis,

a central platform having a load bearing surface in a plane substantially parallel to a long axis of the crossbar, the central platform having a bottom side equipped with a coupling device for connecting the platform to the crossbar,

first and second wing assemblies, wherein the central platform has first and second lateral edge portions, the first wing assembly being pivotally attached to the first lateral edge portion, and the second wing assembly being pivotally attached to the second lateral edge portion, each wing portion being independently moveable from a collapsed position in which the wing portion is substantially parallel with the central platform to one or more raised positions for cradling a boat hull.

A1. The rack system of paragraph A, wherein each wing portion may be ratcheted upward, an actuator being provided to release the wing portion from a raised position to its collapsed position.

A2. The rack system of paragraph A, wherein the central platform has a roller assembly on a trailing edge to assist loading of a boat on to the rack system.

A3. The rack system of paragraph A, wherein each wing assembly has a roller assembly on a trailing edge to assist loading of a boat on to the rack system.

A4. The rack system of paragraph A, wherein each wing assembly includes a padded frame pivotally mounted on an arm structure.

A5. The rack system of paragraph A, wherein the coupling device is configured for clamping a slot in the crossbar.

A6. The rack system of paragraph A, further comprising a lock device preventing the coupling device from being removed from the crossbar without a matching key.

B. A system for carrying a boat on a vehicle having an elongate axis parallel to a direction of vehicular travel, the system comprising:

a crossbar and a pair of clamp devices configured to mount the crossbar on top of a vehicle, the crossbar being substantially perpendicular to the elongate axis; and

a load-carrying device mounted on the crossbar, the load-carrying device including

a central platform having a major surface facing generally upward, a first support arm pivotably connected to a first lateral edge of the central platform, and a second support arm pivotably connected to a second lateral edge of the central platform opposite the first lateral edge, each support arm respectively including a resilient shell operatively attached to an upper surface of the arm, each resilient shell including a load-bearing face;

wherein each support arm is independently pivotable with respect to the central platform.

B1. The system of paragraph B, the load-carrying device further comprising a locking mechanism operatively connected to the first support arm, wherein the locking mechanism is configured to selectively lock the first support arm into at least a first position and a second position relative to the central platform.

B2. The system of paragraph B1, wherein the locking mechanism comprises a hub attached to the first support arm, the hub having a first mating surface, and a rotationally fixed member having a second mating surface, wherein the locking mechanism is configured to selectively engage complementary teeth of the first and second mating surfaces.

B3. The system of paragraph B2, wherein the complementary teeth of the first and second mating surfaces are biased toward engagement with each other, and the locking mechanism comprises an actuator configured to urge the complementary teeth out of engagement with each other.

B4. The system of paragraph B, wherein each resilient shell is operatively connected to the respective support arm by a pivotable connection.

B5. The system of paragraph B4, wherein the resilient shell has a first end and a second end, and the pivotable connection is spaced from both the first end and the second end.

B6. The system of paragraph B5, wherein the pivotable connection includes a spring configured to bias the resilient shell against pivoting on the support arm.

B6. The system of paragraph B, wherein the load-carrying device is configured to pivot between a collapsed position in which the faces of the shells and the major surface of the central platform are substantially coplanar, and one or more in-use positions in which the support arms are fixed in an upwardly pivoted orientation.

B7. The system of paragraph B, wherein each support arm is pivotable about a respective axis that is substantially parallel to the elongate axis.

B8. The system of paragraph B, the load-carrying device further including a clamp operatively connected to the central platform, the clamp being configured to attach the device to the crossbar.

B9. The system of paragraph B8, wherein the crossbar includes a longitudinal slot having opposing lip portions, and the clamp includes a shaped cleat having a head portion insertable into the slot and configured to attach the device to the crossbar by clamping the lip portions between the head portion and the central platform.

B10. The system of paragraph B9, wherein the clamp further includes an actuator having a cam handle, the cam handle configured such that pivoting the cam handle from a first position to a second position causes the cleat to move between an unclamped position and a clamped position.

B11. The system of paragraph B, wherein each support arm further includes an aperture passing through the arm adjacent to a distal end of the arm.

B12. The system of paragraph B11, wherein peripheral enclosure of the aperture is incomplete.

C. A load-carrying device for use on a vehicle rack, the device comprising:

a base having a major surface and a mounting surface opposite the major surface and including a clamp configured to secure the base to a crossbar of a vehicle rack;

a first wing assembly pivotably connected to a first lateral edge of the base; and

a second wing assembly pivotably connected to a second lateral edge of the base opposite the first lateral edge, each wing assembly respectively including an elongate support arm pivotably attached to the base, a load-bearing portion having a load-bearing surface and operatively attached to the support arm, and a locking mechanism operatively attached to the support arm;

wherein each wing assembly is configured to pivot independently on an axis substantially perpendicular to a long axis of the crossbar; and

wherein each locking mechanism is configured to selectively fix the respective support arm in at least a first position in which the wing assembly is substantially parallel to the major surface of the base and a second position in which the wing assembly is pivoted at an oblique angle relative to the major surface of the base.

C1. The device of paragraph C, wherein each locking mechanism comprises a hub attached to the respective support arm, the hub having a first mating surface, and a rotationally fixed member having a second mating surface, wherein the locking mechanism is configured to selectively engage complementary teeth of the first and second mating surfaces.

C2. The system of paragraph C1, wherein the complementary teeth of the first and second mating surfaces are biased toward engagement with each other, and the locking mechanism comprises an actuator configured to urge the complementary teeth out of engagement with each other.

C3. The system of paragraph C1, wherein the complementary teeth are ramped such that the wing assembly is free to ratchet in a pivoting direction generally toward the load-bearing surface.

C4. The system of paragraph C, wherein each load-bearing portion is operatively connected to the respective support arm by a pivotable connection.

C5. The system of paragraph C4, wherein the load-bearing portion has a first end and a second end, and the pivotable connection is spaced from both the first end and the second end.

C6. The system of paragraph C5, wherein the pivotable connection includes a spring configured to bias the load-bearing portion against pivoting on the support arm.

C7. The system of paragraph C, wherein the clamp includes a shaped cleat having a head portion insertable into a slot in a crossbar.

C8. The system of paragraph C7, wherein the clamp further includes an actuator having a cam handle, the cam handle configured such that pivoting the cam handle from a first position to a second position causes the cleat to move between an unclamped position and a clamped position.

C9. The system of paragraph C, wherein each support arm further includes an aperture passing through the arm adjacent to a distal end of the arm.

C10. The system of paragraph C9, wherein peripheral enclosure of the aperture is incomplete.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A rack system for carrying a boat on a vehicle having an elongate axis parallel to a direction of vehicular travel, the system comprising
a crossbar and a pair of clamp devices configured to mount the crossbar on top of a vehicle in an orientation perpendicular to the elongate axis,
a central platform having a load bearing surface in a plane substantially parallel to a long axis of the crossbar, the central platform having a bottom side equipped with a coupling device for connecting the platform to the crossbar,
first and second wing assemblies, wherein the central platform has first and second lateral edge portions, the first wing assembly being pivotally attached to the first lateral edge portion, and the second wing assembly being pivotally attached to the second lateral edge portion, each wing portion being independently moveable from a collapsed position in which the wing portion is substantially parallel with the central platform to one or more raised positions for cradling a boat hull.

2. The rack system of claim 1, wherein each wing portion may be ratcheted upward, an actuator being provided to release the wing portion from a raised position to its collapsed position.

3. The rack system of claim 1, wherein the central platform has a roller assembly on a trailing edge to assist loading of a boat on to the rack system.

4. The rack system of claim 1, wherein each wing assembly has a roller assembly on a trailing edge to assist loading of a boat on to the rack system.

5. The rack system of claim 1, wherein each wing assembly includes a padded frame pivotally mounted on an arm structure.

6. The rack system of claim 1, wherein the coupling device is configured for clamping a slot in the crossbar.

7. The rack system of claim 1, further comprising a lock device preventing the coupling device from being removed from the crossbar without a matching key.

8. A system for carrying a boat on a vehicle having an elongate axis parallel to a direction of vehicular travel, the system comprising:
a crossbar and a pair of towers configured to mount the crossbar on top of a vehicle, the crossbar being substantially perpendicular to the elongate axis; and
a load-carrying device mounted on the crossbar, the load-carrying device including
a central platform having a major surface facing generally upward, a first support arm pivotably connected to a first lateral edge of the central platform, and a second support arm pivotably connected to a second lateral edge of the central platform opposite the first lateral edge, each support arm respectively including a resilient shell operatively attached to an upper surface of the arm, each resilient shell including a load-bearing face;
wherein each support arm is independently pivotable with respect to the central platform.

9. The system of claim 8, the load-carrying device further comprising a locking mechanism operatively connected to the first support arm, wherein the locking mechanism is configured to selectively lock the first support arm into at least a first position and a second position relative to the central platform.

10. The system of claim 9, wherein the locking mechanism comprises a hub attached to the first support arm, the hub having a first mating surface, and a rotationally fixed member having a second mating surface, wherein the locking mechanism is configured to selectively engage complementary teeth of the first and second mating surfaces.

11. The system of claim 10, wherein the complementary teeth of the first and second mating surfaces are biased toward engagement with each other, and the locking mechanism comprises an actuator configured to urge the complementary teeth out of engagement with each other.

12. The system of claim 8, wherein each resilient shell is operatively connected to the respective support arm by a pivotable connection.

13. The system of claim 12, wherein the resilient shell has a first end and a second end, and the pivotable connection is spaced from both the first end and the second end.

14. The system of claim 13, wherein the pivotable connection includes a spring configured to bias the resilient shell against pivoting on the support arm.

15. The system of claim 8, wherein the load-carrying device is configured to pivot between a collapsed position in which the faces of the shells and the major surface of the central platform are substantially coplanar, and one or more in-use positions in which the support arms are fixed in an upwardly pivoted orientation.

16. The system of claim 8, wherein each support arm is pivotable about a respective axis that is substantially parallel to the elongate axis.

17. The system of claim 8, the load-carrying device further including a clamp operatively connected to the central platform, the clamp being configured to attach the device to the crossbar.

18. The system of claim 17, wherein the crossbar includes a longitudinal slot having opposing lip portions, and the clamp includes a shaped cleat having a head portion insertable into the slot and configured to attach the device to the crossbar by clamping the lip portions between the head portion and the central platform.

19. The system of claim 18, wherein the clamp further includes an actuator having a cam handle, the cam handle configured such that pivoting the cam handle from a first position to a second position causes the cleat to move between an unclamped position and a clamped position.

20. The system of claim 8, wherein each support arm further includes an aperture passing through the arm adjacent to a distal end of the arm.
